(19) United States
(12) Patent Application Publication
(10) Pub. No.: US 2013/0126461 A1
(43) Pub. Date: May 23, 2013

(54) Baby Bottle-Like, Single-Use Disposable Container

(71) Applicant: Carmen P. Brown, Springville, UT (US)

(72) Inventor: Carmen P. Brown, Springville, UT (US)

(21) Appl. No.: 13/510,619

(22) PCT Filed: Nov. 17, 2010
(86) PCT No.: PCT/ES10/00473

§ 371 Date: Aug. 6, 2012

(30) Foreign Application Priority Data
Nov. 20, 2009 (ES) US00901639

(51) Int. Cl. A61J 9/00

(52) U.S. Cl. CPC A61J 9/00
USPC 215/11.6; 215/11.1

(57) ABSTRACT

A baby bottle-like, single-use disposable container comprises a vessel and an upper element (teat, measuring element or bowl) with a hermetically closed capsule attached to the outside of the vessel, either by a string or by an adhesive element, or housed in the base of the baby bottle, the entire assembly being protected by a sealing wrap.

This invention is a type of portable feeding bottle designed for the feeding of babies and has three principal objectives. Firstly, it must be easily transportable in optimal hygiene conditions. Secondly, it must allow for the preparation of the bottle at any time and in any place, including heating the product at the moment when a liquid and a powder product are mixed, having previously been stored in separate containers. Thirdly, it must be disposable once consumed. The bottle contains the correct quantity of powder and liquid for one single use without having any left over. In addition to all of the above, with the aim of taking care of the environment, it is considered very important that the bottle be made of recyclable material.

This invention represents an improved version of another with application number U 200700808, presented by the same inventor on Apr. 19, 2007 and published Aug. 1, 2007.

### TECHNOLOGY SECTOR TO WHICH THE INVENTION IS RELATED

The invention presented affects the Basic Life Needs Sector, specifically regarding the Chapter on Health, Protection, Entertainment, having a bearing on the industry of the manufacture of products and utensils related to feeding babies.

### PRECEDENTS TO THIS INVENTION

As this is something relating to the continuation of our species, it is clear that there is a huge number of precedents relating to the subject which concerns us here.

The preparation of feeding bottles is a habitual and repetitive activity which mothers or other people looking after babies usually carry out within their own homes. However, these days, having to travel with young or newborn children is very common and necessary on many occasions. As such, parents or other babysitters appreciate being able to count on facilities which make the preparation of bottles much easier.

Upon leaving the house, simple things such as finding hot water or a sterilized recipient become much more complicated. It is also necessary to have a can of powdered milk with the corresponding dispenser.

These complications often arise at the most inopportune moments since babies do not respect times or locations. The need to give a feeding bottle may come up in an airport, a shopping mall or the middle of the countryside.

The solution proposed is also valid for older children who require, in a glass, a drink consisting of a mixture of powdered milk or similar and water. The creator of this invention has taken these matters into account and has improved certain details which had not been considered in the Application previously mentioned.

This invention resolves the above-mentioned problems in a universal, simple and innovative way by noticeably improving upon solutions which can be found in the current market.

### DESCRIPTION OF THE INVENTION

This invention, as has already been mentioned in the introduction, is a portable device designed for feeding babies, similar to a baby's bottle. It has been created in order to resolve the problems mentioned above in a such a way that, when the time comes, the mother or person looking after a baby has a disposable, single-use recipient with a small, hermetic capsule which holds powder, and a quantity of liquid. These are mixed in order to create a drink suitable for a baby.

In other words, the parent or babysitter has a bottle made of plastic, glass or any other recyclable material, preferably transparent or translucent for easier control of the contents, which can be used to feed the baby in any circumstances relating to time or place. This bottle contains liquid which acts as a solvent for the product holding the nutrients in the form of powdered milk or other powdered mixtures, as well as suitable vitamin components for feeding the baby according to their age.

The invention is differentiated from others by the fact that the powder product contained in a small, hermetic recipient made of card, cardboard, plastic, etc. forms part of the bottle, being fixed by means of a piece of string or adhesive. The alternative possibility has also been considered that the bottle holding the liquid could have some type of cavity in its body to guarantee that the powder is firmly fixed and does not go missing as a result of an accident.

The main bottle has a teat which will allow the baby to comfortably consume the drink once the mixing has taken place. It is understood that there is a need that all of this must be protected from external contaminants, and so the invention is provided covered in wrapping which can be easily removed at the moment of use.

As an alternative solution, the inventor has also considered the possibility of substituting the teat with a type of cup which is more appropriate for older children to use who no longer require feeding through the use of bottles and who are capable of drinking directly from a cup. The powdered substance is found, as in the other case, in a hermetic capsule attached to the main bottle through the use of a piece of string, adhesive or any other method, and the bottle is protected with a light covering which, working like a seal, guarantees the hygiene of the sterilized elements within.

Another alternative solution is to substitute the aforementioned cup with a dispenser, with the rest of the components being identical.

In all cases, both the main bottle and the attached hermetic capsule are made of recyclable material for the clear reasons of caring for the environment and complying with legislation which is now common throughout the most-developed countries.

In the figures included in this document, this series of alternatives is clearly described which must be interpreted in their widest senses and not restrictively.

### BRIEF DESCRIPTION OF THE IMAGES

Four figures have been included to assist in understanding the invention. These are all schematics and must be interpreted as illustrations of versions of the invention though this does not exclude other possibilities with respect to the idea presented.

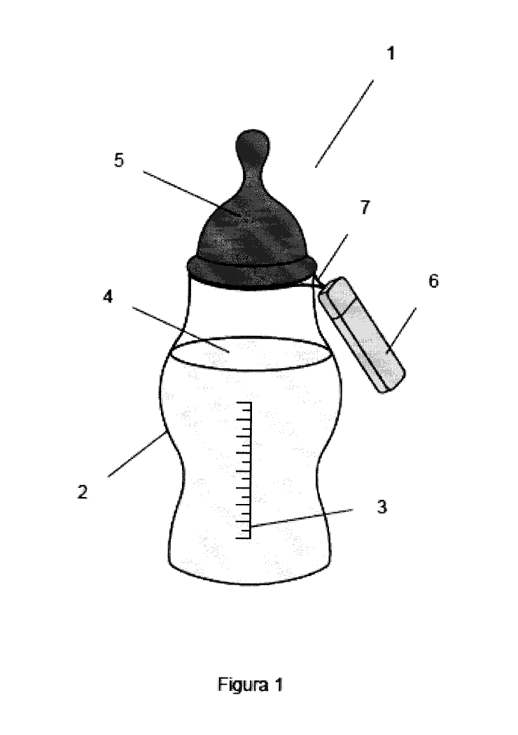

FIG. 1

This figure represents the basic idea of the invention and consists of a standard bottle, containing the solvent, a teat to help the baby consume the drink, and a capsule containing the necessary powder for the drink. The following elements are specified:

1.—Disposable bottle

2.—Cup

3.—Graduated scale

4.—Solvent

5.—Teat

6.—Capsule

7.—Piece of string

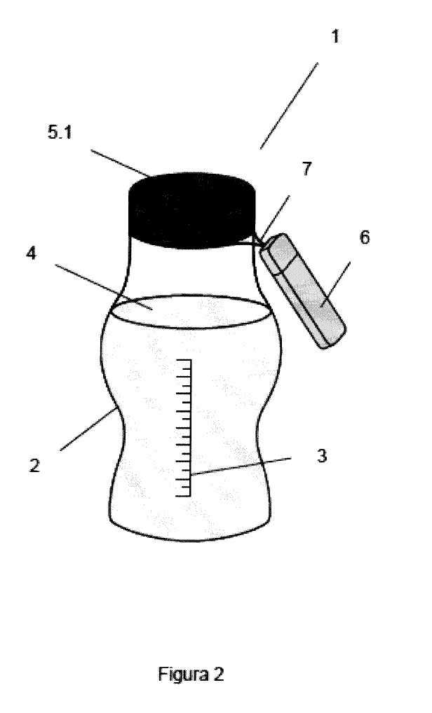

FIG. 2

This figure shows an alternative in which the teat is substituted by a cup for possible use by older children.

The same elements are specified as in the previous figure with the following added:

5.1.—Cup

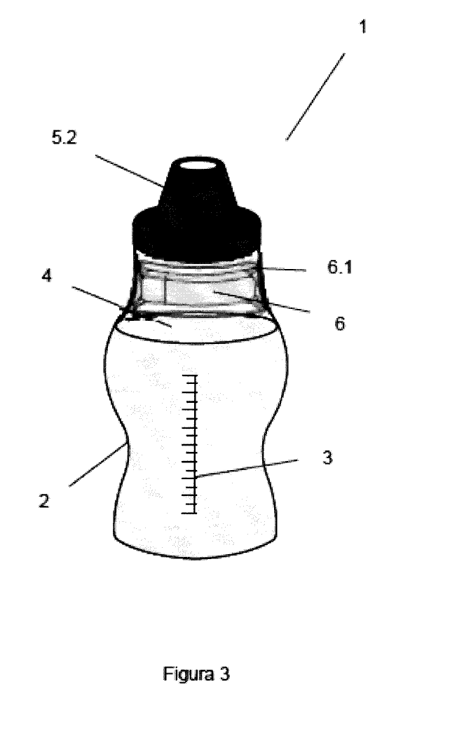

FIG. 3

This figure represents another alternative to the invention in which the teat from (FIG. 1) or the cup from (FIG. 2) is substituted by a dispenser. In addition, in this variant, the capsule is fixed to the bottle with a plastic adhesive film.

In addition to the above elements, the following are specified:

5.2.—Dispenser

6.1.—Adhesive film

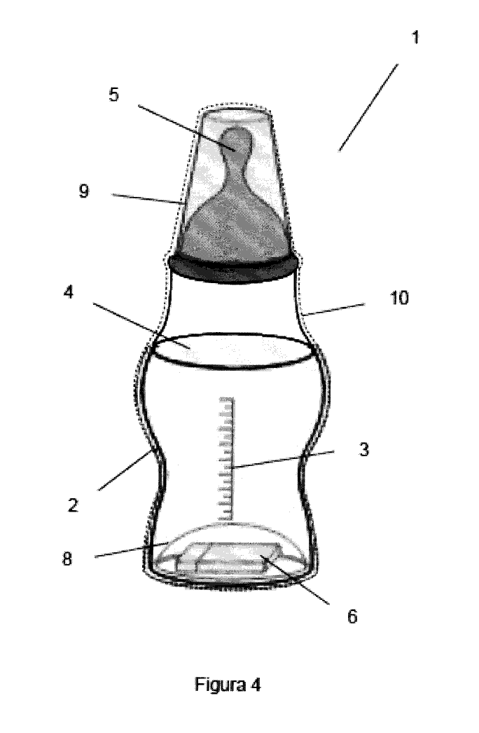

FIG. 4

This figure also represents another alternative which improves, in a certain way, on the previous ones. It is the most complete with a presentation which makes transportation and use much easier, as well as having excellent hygiene characteristics.

In addition to the above elements, the following are specified:

8.—Cavity

9.—Protective cap

10.—Sealing wrapper

### DESCRIPTION OF PREFERRED FORM OF BOTTLE

In the most basic preferred form, the improved disposable drinking bottle designed especially for babies (1) (FIGS. 1 to 4) consists of a portable device similar to a feeding bottle designed for feeding babies or young children which basically consists of a body (2), shaped like a typical feeding bottle, with a graduated scale (3) which is filled completely or partially with a liquid solvent (4) which could be pure water, suitable for feeding babies, or water with an added physiological saline solution. The body (2) is sealed at its upper edge by a standard teat (5) found within the market, and has a capsule (6) attached which contains the powdered nutritional product designed to be dissolved (before being drunk by the baby) in the liquid solvent (4). The capsule (6) is joined to the bottle (1) by means of a piece of string (7) to ensure it does not become lost while being transported.

The improved disposable drinking bottle designed especially for babies (1) is, as its name indicates, designed for single use and to feed babies on occasional trips in which carrying a traditional feeding bottle with its teat together with the powdered product, usually somewhat bigger than the bottle itself, is not desired or practical.

At the moment of use, the mother or person looking after the baby simply opens the capsule (6) and pours its contents into the body of the bottle (2) containing the solvent (4), and then shakes it until well dissolved.

Once the baby has consumed the drink, it is thrown away in one of the designated places, remembering that, as it is made from recyclable material, it is necessary, or at least desirable, to place it in one of the specific containers located in the appropriate locations by authorities in practically all towns and cities.

The inventor has also developed other alternatives to this basic form. In one of them, as represented in (FIG. 2), the teat (5) is replaced by a cup (5.1) which, either threaded or by other system, preserves the integrity of the liquid solvent (4) and which can be easily removed when the time comes. After the mixture with the powder in the capsule (6) has been completed, the cup (5.1) can then be used to hold the drink and used by older children as if it were any other normal cup.

Another manufacture method is that represented schematically in (FIG. 3). In this figure, the teat (5) is replaced by a dispenser (5.2) through which the drink can be consumed directly once the mixture has been prepared. In this case, the capsule (6) is shown as being attached to the body of the bottle (2) by means of a transparent, plastic adhesive film which replaces the piece of string (7).

Finally, the inventor has conceived of a further-improved method of manufacture which is represented in (FIG. 4). Here, the teat (5) is covered with a protective cap (9). The body of the bottle (2) can be seen to have a hemispherical cavity (8) at the bottom in which the capsule (6) containing the powder is held. Finally, the entire improved disposable drinking bottle specially designed for babies (1) is covered with a sealing wrapper (10) for protection during transport.

It is understood that it is possible to manufacture any combination of the aforementioned solutions to satisfy the needs presented in each particular case.

In all cases, the capsule (6) and the body of the bottle (2) will be manufactured, as has been previously mentioned, from recyclable material and, preferably, from a material which protects its contents from the harmful effects of solar rays or any other type of radiation.

To further develop the objective of this invention, it has also been considered that the cavity (8) could also hold another capsule, similar to (6), with a powdered product enriched with cereals. Finally, within this cavity (8), or in any other location, there could also be a product within a capsule which could generate exothermic reactions with the aim of heating the nutritional mixture immediately prior to being consumed by the baby.

It is not considered necessary to be more explicit regarding the contents of this description for an expert in the matter to be able to understand the scope and advantages deriving from this invention, as well as to develop it and put it into practice. However, it must be understood that the invention has been described according to a preferred and idealized method of manufacture and may, as such, be subject to modifications without these having a negative impact or necessitating changes to the basics of said invention. In other words, the terms in which this preferred description have been expressed must be always taken in their widest possible senses.

1. Improved disposable drinking bottle specially designed for babies (1) which consists of the body of the bottle (2) designed to hold a liquid product (4) and an upper element (5, 5.1, 5.2) which covers the mouth of the bottle (2). They are differentiated from other products by the fact that they are disposable, single use, and the use of a small, hermetic capsule (6) containing a quantity of powder designed to be mixed with a liquid solvent (4) consisting of pure water, specifically for the feeding of babies. The entire bottle, having been correctly sterilized, is covered, in some or all cases, by a sealing wrapper (10), and all materials used in the manufacture of this product are recyclable.

2. Improved disposable drinking bottle specially designed for babies, as per the first claim, with the difference that it has means (6.1, 7) of externally fixing the hermetic container to the body of the bottle (2).

3. Improved disposable drinking bottle specially designed for babies, as per the first claim, with the difference that the hermetic capsule (6) is located in a cavity (8) built into the base of the body of the bottle (2) and can be removed.

4. Improved disposable drinking bottle specially designed for babies, as per the first or third claims, with the difference that the upper element consists of a teat (5) and the bottle or the body of the bottle (2) is shaped as a standard feeding bottle with a cavity in its base.

5. Improved disposable drinking bottle specially designed for babies, as per the first or third claims, with the difference that the upper element consists of a cup (5.1).

6. Improved disposable drinking bottle specially designed for babies, as per the first or third claims, with the difference that the upper element consists of a dispenser (5.2).

7. Improved disposable drinking bottle specially designed for babies, as per the first claim, with the difference that, in addition to a hermetic capsule (6), it has another, also hermetic, with a powdered product which is enriched with cereals.

8. Improved disposable drinking bottle specially designed for babies, as per the first and seventh claims, with the difference that the body of the bottle (2) and the hermetic capsules (6) are made of a material which protects the solvent (4) and the powdered material against the harmful effects of solar rays or any other types of radiation.

9. Improved disposable drinking bottle specially designed for babies, as per the first claim, with the difference that the body (2), rather than pure, balanced water designed for feeding babies, contains a physiological saline solution.

10. Improved disposable drinking bottle specially designed for babies, as per the above claims, with the difference that autonomous external elements can be presented and provided which generate, at will, exothermic reactions in order to heat the bottle immediately prior to consumption.
SUMMARY
Improved disposable drinking bottle characterized by the fact that the body of the bottle and the upper element are disposable after a single use, that it includes means of fixing the capsule to the bottle, that the capsule is hermetic, and that the upper element consists of either a teat or a cup. It is also characterized by the fact that the upper element may consist of a dispenser, that it has a second hermetic capsule, that the material used to manufacture the bottle protects the solvent, that it may contain a physiological saline solution, and that autonomous external elements may be introduced.
